(19) United States
(12) Patent Application Publication
(10) Pub. No.: US 2024/0241738 A1
(43) Pub. Date: Jul. 18, 2024

(54) COMMUNICATION METHOD, APPARATUS AND SYSTEM

(71) Applicant: BEIJING CO WHEELS TECHNOLOGY CO., LTD, Beijing (CN)

(72) Inventor: Wenbin GUI, Beijing (CN)

(21) Appl. No.: 18/621,314

(22) Filed: Mar. 29, 2024

Related U.S. Application Data
(63) Continuation of application No. PCT/CN2022/121375, filed on Sep. 26, 2022.

(30) Foreign Application Priority Data
Sep. 30, 2021 (CN) 202111162025.8

(51) Int. Cl. G06F 9/451; G06F 11/30

(52) U.S. Cl. CPC G06F 9/451; G06F 11/3013; G06F 11/302

(57) ABSTRACT

A communication method performed by a source system in a vehicle includes: monitoring an interface startup request of an application, in which the interface startup request includes identification information of a target screen to be started; determining, based on the identification information, whether a target system corresponding to the target screen is the source system; in response to the target system corresponding to the target screen being the source system, starting an interface of the application on the target screen; and in response to the target system corresponding to the target screen not being the source system, sending the interface startup request to the target system, to enable the target system to start the interface of the application on the target screen.

### CROSS REFERENCE TO RELATED APPLICATIONS

This application is a continuation of International Application No. PCT/CN2022/121375, filed on Sep. 26, 2022, which claims priority to Chinese Patent Application No. 202111162025.8, filed on Sep. 30, 2021, the entire disclosures of which are incorporated herein by reference.

### TECHNICAL FIELD

The disclosure relates to the technical field of new energy vehicles, in particular to a communication method, a communication apparatus and a system.

### BACKGROUND

With the rapid development of the automotive industry, vehicle functions are increasing, and many vehicles are equipped with an intelligent driving cabin. The intelligent driving cabin is provided with an entertainment system, which includes entertainment applications on the system screen to entertain passengers.

In actual applications, requirements of the application on the performance and computing power are increasing, and the current requirements cannot be satisfied by a single system. Therefore, the intelligent driving cabin may be configured with multiple operating systems.

### SUMMARY

According to a first aspect, embodiments of the disclosure provide a communication method, performed by a source system in a vehicle, in which the source system is any of a plurality of systems in the vehicle. The method includes:
monitoring an interface startup request of an application, in which the interface startup request includes identification information of a target screen to be started;
determining, based on the identification information, whether a target system corresponding to the target screen is the source system;
in response to the target system corresponding to the target screen being the source system, starting an interface of the application on the target screen; and
in response to the target system corresponding to the target screen not being the source system, sending the interface startup request to the target system, to enable the target system to start the interface of the application on the target screen.

According to a second aspect, embodiments of the disclosure provide a communication method, performed by a target system in a vehicle, in which the target system is any of a plurality of systems in the vehicle. The method includes:
receiving an interface startup request of an application sent by a first system in a vehicle, in which the first system is different from the target system, the interface startup request includes identification information of a target screen to be started, and the first system is a system in which the application is installed; and
starting an interface of the application on the target screen based on the identification information.

According to a third aspect, embodiments of the disclosure provide a source system. The source system includes: a processor and a memory for storing instructions executable by the processor. The processor is configured to:
monitor an interface startup request of an application, in which the interface startup request includes identification information of a target screen to be started;
determine, based on the identification information, whether a target system corresponding to the target screen is the source system;
in response to the target system corresponding to the target screen being the source system, starting an interface of the application on the target screen; and
in response to the target system corresponding to the target screen not being the source system, sending the interface startup request to the target system, to enable the target system to start the interface of the application on the target screen.

These or other aspects of the disclosure will be more concisely understood in the following description of embodiments.

### BRIEF DESCRIPTION OF THE DRAWINGS

In order to more clearly illustrate the technical solutions in embodiments of the disclosure or the technical solutions in the related art, the following will briefly introduce the accompanying drawings that need to be used in the description of embodiments or the related art. Obviously, the accompanying drawings in the following description are some of embodiments of the disclosure, and it is possible for those skilled in the art to obtain other drawings based on the drawings without inventive work.

FIG. 1 is a flowchart illustrating a communication method according to an embodiment of the disclosure.

FIG. 2 is a flowchart illustrating another communication method according to an embodiment the disclosure.

FIG. 3 is a flowchart illustrating still another communication method according to an embodiment of the disclosure.

FIG. 4 is a schematic diagram illustrating a vehicle including systems according to an embodiment of the disclosure.

FIG. 5 is a schematic diagram illustrating a communication method according to an embodiment of the disclosure.

FIG. 6 is a block diagram illustrating a communication apparatus according to an embodiment of the disclosure.

FIG. 7 is a block diagram illustrating another communication apparatus according to an embodiment of the disclosure.

FIG. 8 is a block diagram illustrating a communication system according to an embodiment of the disclosure.

### DETAILED DESCRIPTION

In order to enable those in the art to better understand the technical solutions of the disclosure, the technical solutions in embodiments of the disclosure will be clearly and completely described below in combination with the accompanying drawings in embodiments of the disclosure.

Some of the processes described in the specification, the claims of this disclosure and the accompanying drawings described above include a plurality of operations that are shown in a certain order. However, it should be clearly understood that these operations may be performed in any order other than the shown order or in parallel, and that the serial numbers of the operations, such as 101, 102, and the like, are merely used to distinguish the operations, and the serial numbers do not imply any order of execution. In addition, the processes may include more or fewer operations, and the operations may be executed sequentially or in parallel. It should be noted that the terms “first” and “second” are used herein to distinguish different messages, devices, modules, etc., and do not represent a sequential order, nor do they define different types.

Embodiments of the disclosure may be applied in a vehicle, especially a vehicle configured with an intelligent driving cabin. The intelligent driving cabin is provided with an entertainment system, which includes entertainment applications on the system screen to entertain passengers.

In actual applications, requirements of the application on the performance and computing power are increasing, and the current requirements cannot be satisfied by a single system. Therefore, the intelligent driving cabin may be configured with multiple systems. Moreover, when an application in a certain system starts an interface, the interface may only be started on a screen of the current system, resulting in a poor user experience.

Therefore, from the perspective of whether the interface of the application in the current system may be started on the screen of another system, after a series of thoughts and experiments, the inventor proposed the technical solutions of the disclosure, which include a communication method that may be performed by any of the systems in the vehicle. The method includes: monitoring an interface startup request of an application, in which the interface startup request includes identification information of a target screen to be started; determining, based on the identification information, whether a target system corresponding to the target screen is the current system; in response to the target system corresponding to the target screen being the current system, starting an interface of the application on the target screen; and in response to the target system corresponding to the target screen not being the current system, sending the interface startup request to the target system, to enable the target system to start the interface of the application on the target screen.

In embodiments of the disclosure, by monitoring the interface startup request of the application, it is determined whether the target system corresponding to the target screen to be started is the current system. When it is determined that the target system is the current system, it indicates that the interface of the application will be started on the screen of the current system, and thus the interface of the application is started directly on the target screen of the current system. When it is determined that the target system is not the current system, it indicates that the interface of the application will be started on the screen of another system. At this time, the interface startup request is sent to the target system, so that the interface of the application is started on the target screen of the target system. Therefore, the interface of the application in the system may be started on the screen of any system without the need to process the application, and it is possible to start the interface of the application on the screen of any system simply based on the identification information of the target screen to be started, which is simple and easy to implement, thereby improving the user experience.

The technical solutions according to embodiments of the disclosure will be described clearly and completely in the following in combination with the accompanying drawings in embodiments of the disclosure. Obviously, the described embodiments are only a part of embodiments of the disclosure, and not all of the embodiments. Based on embodiments in the disclosure, all other embodiments obtained by those skilled in the art without inventive work fall within the scope of protection of the disclosure.

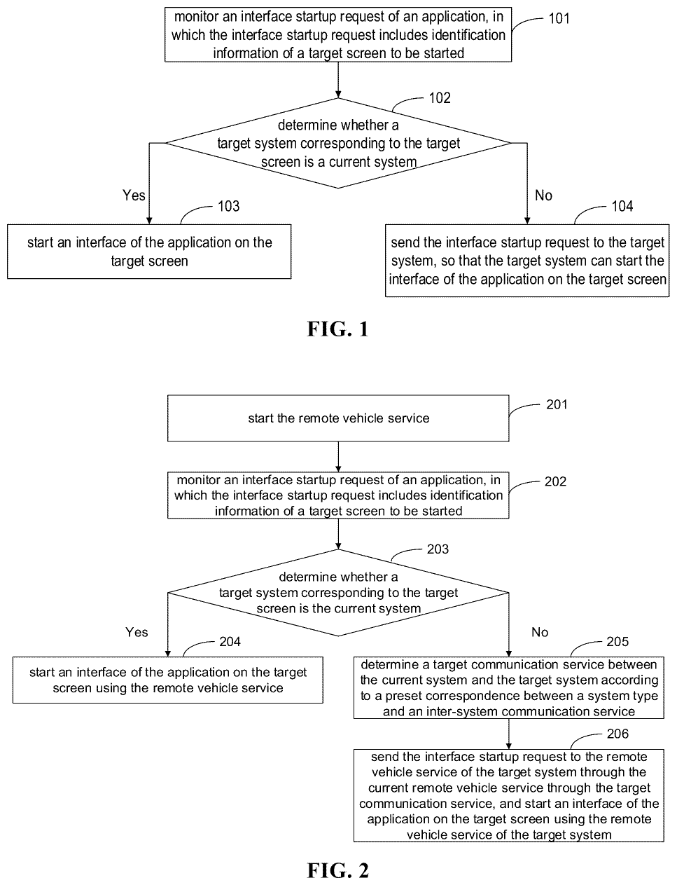

FIG. 1 is a flowchart illustrating a communication method according to an embodiment of the disclosure. As illustrated in FIG. 1, the method includes the following blocks 101-104.

At block 101, an interface startup request of an application is monitored.

The interface startup request includes identification information of a target screen to be started.

Embodiments of the disclosure may be performed by any of the systems of the vehicle. The system for performing the communication method related to FIG. 1 is called “source system”. The vehicle may include a plurality of systems, i.e., at least two systems. The type of the system may include a Linux system (GNU/Linux, which is a Unix-like operating system that is free to use and freely distributed, and is a POSIX-based multi-user, multi-tasking, multi-threading and multi-CPU operating system), an Android system (a Linux kernel-based, free and open-source operating system (which does not contain GNU components)), etc. In practical applications, the number and type of systems may be set depending on the actual vehicle. For example, the vehicle may include 2 Android systems, 3 Linux systems, or 1 Android system and 2 Linux systems.

In some embodiments, the system in the vehicle may be a System on Chip (SOC). The vehicle may include a plurality of SOCs, each configured with one or more screens.

Each screen of each SOC may be bound to one or more users. Each user has a respective user identifier (ID). In a following example where each screen is bound with one user, when the screen is bound with a user ID, a set of applications corresponding to the user ID may be displayed on the screen, which includes one or more applications. Different user IDs correspond to different sets of applications, and these sets of applications are independent of each other. In addition, user interfaces displayed on screens bound with different user IDs are also independent of each other. Correspondingly, user data corresponding to different user IDs is independent of each other.

As an example where an SOC is configured with two screens and each screen is bound with a respective user ID, when a first user logs in to a first screen of the SOC using a first user ID, the first screen of the SOC may display a first interface on which there is a first application APP1. The first application APP1 is configured by the first user based on his/her own needs. Running the first application APP1 on the SOC will generate first user data. When a second user logs in to a second screen of the SOC using a second user ID, the second screen of the SOC may display a second interface on which there is a second application APP2. The second application APP2 is configured by the second user based on his/her own needs. Running the second application APP2 on the SOC will generate second user data. The second user data does not have any impact on the first user data. That is, the second user data will not cause, for example, any modifications, deletions, or additions to the first user data. The first application APP1 may be the same or different from the second application APP2, and the first user interface may be the same or different from the second user interface.

Each system may include at least one application, such as an entertainment application (e.g., a video playback application, an audio playback application, and a game application, etc.) or an office application (e.g., a text editing application, and an image drawing application, etc.). The type or number of applications in the system may be set according to the actual application scenario, which is not specifically limited herein.

When an application is launched, the interface startup request of the application is monitored. The interface startup request may include identification information of a target screen to be started. The identification information may include an identifier (ID). In detail, the interface startup request may be generated based on a launching operation from the user on the application. The launching operation from the user on the application may be implemented in a variety of ways.

In some embodiments, the screen of the system may include an icon of the application. The user may trigger an icon of the application on the screen by single-clicking or double-clicking, and the trigger operation is not limited herein. In response to the operation triggered by the user, prompt information for selecting the target screen to be started may be displayed on the screen. For example, an input box of target screen information may be displayed, and the user may enter the identification information of the target screen into the input box. As another example, a selection list including all the screen identification information is displayed, and the user may select the identification information of the target screen in the list. Based on the target screen selected by the user, the interface startup request including the identification information of the target screen may be generated.

In other embodiments, the system may include an audio collection component for obtaining voice information of the user. The voice information may include an application selected by the user and a target screen to be started. For example, the voice information may be “launching the video playback application on screen A”. That is, the application selected by the user is the video playback application, and the target screen to be started is screen A. Based on the target screen selected by the user, the interface startup request that includes the identification information of the target screen may be generated.

In practical applications, the launching operation of the application from the user may be implemented in other ways, which is not limited in embodiments of the disclosure.

At block 102, it is determined, based on the identification information, whether a target system corresponding to the target screen is the current system. When it is determined that the target system is the current system, the block 103 is performed. When it is determined that the target system is not the current system, the block 104 is performed.

Based on the identification information of the target screen, it may be determined whether the target system corresponding to the target screen is the current system. The current system is a system where the application is installed.

In detail, the target system corresponding to the target screen may be determined based on the identification information. A correspondence between screens and systems may be preset. For example, screen “a” corresponds to system “A”, and screen “b” corresponds to screen “B”. Based on the preset correspondence, the target system corresponding to the target screen may be determined. Afterwards, based on the identification information of the target system and the identification information of the current system, it may be determined whether the target system is the current system. When the identification information of the target system is identical to the identification information of the current system, it is determined that the target system is the current system. When the identification information of the target system is different from the identification information of the current system, it is determined that the target system is not the current system.

At block 103, an interface of the application is started on the target screen.

When it is determined that the target system is the current system, the interface of the application may be started on the target screen of the current system. For example, when the current system is an Android system, the user may directly call an interface starting port of the Android system to start the interface of the application on the target screen. For the implementation of starting the interface of the application on the screen of the current system, reference may be made to the specific implementation in the conventional solution which is not repeated here.

At blocks 104, the interface startup request is sent to the target system, to enable the target system to start the interface of the application on the target screen.

When it is determined that the target system is not the current system, it means that the interface of the application will be started on the screen of another system. At this time, the current system cannot start the interface on the screen of the current system, and it needs to send the interface startup request to the target system, so that the target system may start the interface of the application on the target screen. For the implementation of starting the interface of the application on the target screen corresponding to the target system, reference may be made to the specific implementation in the conventional solutions, which is not repeated here.

In embodiments of the disclosure, by monitoring the interface startup request of the application, it is determined whether the target system corresponding to the target screen to be started is the current system. When it is determined that the target system is the current system, it indicates that the interface of the application will be started on the screen of the current system, and thus the interface of the application is started directly on the target screen of the current system. When it is determined that the target system is not the current system, it indicates that the interface of the application will be started on the screen of another system. At this time, the interface startup request is sent to the target system, so that the interface of the application is started on the target screen of the target system. Therefore, the interface of the application in the system may be started on the screen of any system without the need to process the application, and it is possible to start the interface of the application on the screen of any system simply based on the identification information of the target screen to be started, which is simple and easy to implement, thereby improving the user experience.

In practical applications, the system of the vehicle may include at least one screen. In some embodiments, monitoring the interface startup request of the application in the method may include:
monitoring the interface startup request of the application on any screen.

When the vehicle includes two systems, system A and system B, the system A may include two screens, a front screen a1 and a middle screen a2, and system B may include only one screen, i.e., a rear screen b. When monitoring the interface startup request of the application in the system A, the interface startup request of an application on the front screen a1 and the interface startup request of an application on the middle screen a2 are monitored.

For example, the interface startup request of the audio playback application on the front screen a1 in the system A is monitored, and the interface startup request includes the identification information of the target screen to be started. When the target screen is the middle screen a2, it may be determined that the corresponding target system is the current system A. At this time, the interface of the audio playback application is started on the middle screen a2. When the target screen is a rear screen b1, it may be determined that the corresponding target system is system B, not the current system A. At this time, the interface startup request is sent to system B, and system B starts the interface of the audio playback application on the rear screen b.

For ease of implementation, in some embodiments, each system includes a respective remote vehicle service.

In detail, monitoring the interface startup request of the application includes:
starting the remote vehicle service; and
monitoring the interface startup request of the application by means of the remote vehicle service.

The remote vehicle service means a service procedure that enables the current system to communicate and interact with another system. In embodiments of the disclosure, each system of the vehicle is provided with a respective remote vehicle service, and each system corresponds to a certain remote vehicle service. For example, system A corresponds to remote vehicle service A1, and system B corresponds to remote vehicle service B1.

After the system is powered on and started, an executable program of the remote vehicle service of the system will be launched. After the service startup is completed, the remote vehicle service continuously listens for the interface startup request. For example, the remote vehicle service may provide a corresponding interface to each application in the system, to monitor the interface startup request of each application. In practical applications, the remote vehicle service of the current system may be started and used for monitoring the interface startup request of the application on any screen of the system.

In some embodiments, the remote vehicle service may also be used for starting the interface of the application on the screen. When the system is an Android system, the remote vehicle service may be used for calling the interface starting port of the Android system to start the interface of the application on the screen of the Android system.

In some embodiments, sending the interface startup request to the target system includes:
sending the interface startup request to a remote vehicle service of the target system by means of the remote vehicle service.

In detail, the remote vehicle services of the systems may communicate and interact with each other, to realize communication and interaction between the systems. When the application in the current system requests to start the screen of another system, the remote vehicle service in the current system is used for sending the interface startup request of the application to the remote vehicle service in the target system, so that the remote vehicle service in the target system may start the interface of the application on the target screen. The implementation of the remote vehicle service starting the interface of the application on the screen has been described in the contents of the above described specification and will not be repeated here.

In practical applications, the communication and interaction between different systems of the vehicle may be realized through a communication service. In some embodiments, the communication method further includes:
determining a target communication service between the current system and the target system based on a preset correspondence between system types and communication services that are performed between systems.

Depending on different system types, communication services between the systems are different. For example, when both systems are Android systems, the corresponding communication service may be an Android system communication service (e.g., Distribution Remote Call service, Drc service), which is a Data Distribution Service for Real-Time Systems (DDS) protocol-encapsulated Android system service that may be applied for the communication and interaction between two Android systems.

The above correspondence between the system types and the communication services may be set in advance, so that the target communication service corresponding to the system types of the two systems that are communicated and interacted with each other may be determined based on the preset correspondence. In detail, the communication service between different types of systems may be set based on the actual application scenario, for example, the communication service between an Android system and a Linux system, and the communication service between a Linux system and a Linux system, and will not be repeated herein.

In some embodiments, sending the interface startup request to the target system includes:
sending the interface startup request to the target system by means of the target communication service.

In practical applications, when it is determined that the target screen to be started by the application in the current system is a screen in another system, the target communication service between the current system and the target system may be determined based on the system type of the current system and the system type of the target system, and the interface startup request may be sent to the target system by means of the target communication service.

In detail, the remote vehicle service in the current system may send the interface startup request to the remote vehicle service of the target system via the target communication service.

FIG. 2 is a flowchart illustrating another communication method according to an embodiment of the disclosure. As illustrated in FIG. 2, the method includes the following blocks 201-206.

At block 201, the remote vehicle service is started.

At block 202, the interface startup request of the application is monitored by means of the remote vehicle service.

The interface startup request may include the identification information of the target screen to be started.

At block 203, it is determined, based on the identification information, whether a target system corresponding to the target screen is the current system. When it is determined that the target system corresponding to the target screen is the current system, the block 204 is performed. When it is determined that the target system corresponding to the target screen is not the current system, the blocks 205 and 206 are performed.

At block 204, the interface of the application is started on the target screen by means of the remote vehicle service.

At block 205, a target communication service between the current system and the target system is determined based on a preset correspondence between system types and communication services that are performed between systems.

At block 206, the interface startup request is sent to the remote vehicle service of the target system by means of the remote vehicle service through the target communication service, and the interface of the application is started on the target screen by means of the remote vehicle service of the target system.

In embodiments of the disclosure, for the implementation of blocks 201 to 206, reference may be made to the specific implementation in embodiments shown in FIG. 1, which will not be repeated here.

In the disclosure, the interface startup request may further include launching parameters for the application. For example, the launching parameters for the application may include: an interface size, an application launching mode, a launching animation, etc.

Before sending the interface startup requests to the target remote vehicle service of the target system by means of the remote vehicle service, the method comprises: parsing the interface startup request by the remote vehicle service, obtaining the identification information of the target screen and launching parameters for the application; and serializing the identification information of the target screen and the launching parameters for the application by the remote vehicle service to obtain serialized data. Sending the interface startup request to the target remote vehicle service of the target system by means of the remote vehicle service includes: sending the serialized data to the target remote vehicle service of the target system by the remote vehicle service.

The “serializing” processing means a process of encoding data structures or objects. In the disclosure, data may be serialized into a data format required by the target communication service (such as a Drc service), which is not limited in the disclosure.

In embodiments of the disclosure, the remote vehicle service is started and used for monitoring the interface startup request of the application. It is determined whether the target system corresponding to the target screen to be started is the current system. When it is determined that the target system corresponding to the target screen is the current system, it indicates that the interface of the application will be started on the screen of the current system, and thus the interface of the application is started directly on the target screen of the current system. When it is determined that the target system corresponding to the target screen is not the current system, it indicates that the interface of the application will be started on the screen of another system. Therefore, the interface startup request is sent to the remote vehicle service of the target system by means of the remote vehicle service, so that the interface of the application is started on the target screen of the target system. In this way, the interface of the application in the system may be started on the screen of any system without the need to process the application, and it is possible to start the interface of the application on the screen of any system simply based on the identification information of the target screen to be started, which is simple and easy to implement, thereby improving the user experience.

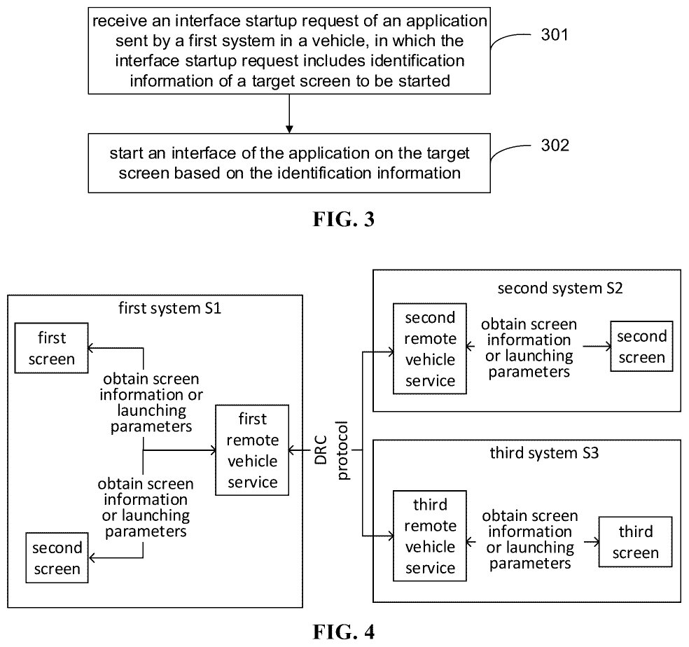

FIG. 3 is a flowchart illustrating still another communication method according to an embodiment of the disclosure. As illustrated in FIG. 3, the method includes the following blocks 301 and 302.

At block 301, an interface startup request of an application sent by a first system in a vehicle is received.

The interface startup request may include the identification information of the target screen to be started. The vehicle may include a plurality of systems. The first system is a system in which the application is installed.

At block 302, an interface of the application is started on the target screen based on the identification information.

In embodiments of the disclosure, the vehicle may include a plurality of systems. For ease of description, the system in which the application is installed may be referred to as the first system. The communication method according to this embodiment of the disclosure may be performed by the target system corresponding to the target screen to be started by the application of the first system. The interface startup request of the application sent by the first system is received, and the interface of the application is started on the target screen based on the identification information of the target screen. The specific implementation method has been described in detail in the foregoing embodiments and will not be repeated here.

In the disclosure, the interface startup request may further include launching parameters for the application.

After receiving the interface startup request of the application sent by the first system of the vehicle, the method includes: deserializing the interface startup request by a target remote vehicle service of the target system, obtaining identification information of the target screen and launching parameters for the application; and starting an interface of the application on the target screen based on the identification information and the launching parameters. For example, the launching parameters may include: an interface size, an application launching mode, or a launching animation, etc.

The “deserializing” processing is a reverse processing of the serializing processing, which is a process of decoding data structures or objects. It is understandable that the deserialization method is not limited in the disclosure.

In embodiments of the disclosure, by receiving the interface startup request sent by the first system in which the application is installed, based on the identification information of the target screen to be started included in the interface startup request, the interface of the application may be started on the target screen. Therefore, the interface of the application of another system may be started on the screen of the current system, and the interface of the application in the system may be started on the screen of any system without the need to process the application. It is possible to start the interface of the application on the screen of any system simply based on the identification information of the target screen to be started, which is simple and easy to implement, thereby improving the user experience.

FIG. 4 is a schematic diagram illustrating a vehicle including systems according to an embodiment of the disclosure. As illustrated in FIG. 4, the vehicle includes 3 systems, namely a first system S1, a second system S2, and a third system S3. Each system may be either an Android system or a Linux system. The first system S1 has a first remote vehicle service, the second system S2 has a second remote vehicle service, and the third system S3 has a third remote vehicle service. In FIG. 4, the first system S1 includes a first screen and a second screen, the second system S2 includes a third screen, and the third system S3 includes a fourth screen.

For example, the first screen may be a central control screen, which may be logged in with the user ID 0 corresponding to a first user. The second screen may be a passenger seat screen, which may be logged in with the user ID 1 corresponding to a second user. The third screen may be a rear seat screen, which may be logged in with the user ID 2 corresponding to a third user. The fourth screen may be a Head Up Display (HUD) screen, which may be logged in with the user ID 3 corresponding to a fourth user.

FIG. 4 illustrates that each system involved in the method according to embodiments of the disclosure is an Android system, and thus the target communication service is the DRC protocol.

A remote vehicle service of each system may listen to an interface startup request of each application on each screen in the system. When a remote vehicle service of a current system monitors that there is an interface startup request of an application on a screen of the current system, the interface startup request is parsed by the remote vehicle service to obtain identification information of a target screen and launching parameters for the application, and a target system is determined based on the identification information of the target screen. In response to determining that the target system is a current system, the remote vehicle service starts the interface of the application on the target screen in the current system. In response to determining that the target system is not the current system, the remote vehicle service serializes the identification information and launching parameters to obtain serialized data, and sends the serialized data to a target remote vehicle service of the target system through a target communication service. The target remote vehicle service may receive the serialized data and perform deserialization processing on the serialized data to obtain the identification information of the target screen and a launching instruction, thereby launching the application on the target screen of the target system. The launching instruction may be the launching parameters.

In the disclosure, after the target remote vehicle service obtains the identification information of the target screen and the launching instruction, the target remote vehicle service may determine whether the application corresponding to the launching instruction has been installed in the target system. In response to determining that the application has been installed on the target system, the interface of the application is started on the target screen of the target system. In response to determining that the application has not been installed in the target system yet, the application may be downloaded and installed in the target system and then launched in the target system, which is not limited in the disclosure.

In the disclosure, after obtaining the identification information of the target screen by parsing the interface startup request, the target remote vehicle service may determine the target screen based on the correspondence between identification information of screens and identification information of systems.

In an example of FIG. 4, when the first remote vehicle service monitors that there is an interface startup request of an application in the first system S1, the first remote vehicle service may parse the interface startup request to obtain the identification information of the target screen and the launching parameters for the application, and determine the target system where the target screen is located based on the identification information of the target screen. When the target system is the first system S1, the first remote vehicle service launches the interface of the application on the target screen of the first system S1. When the target system is the second system S2 or the third system S3, the first remote vehicle service serializes the identification information of the target screen and the launching parameters for the application to obtain serialized data and sends the serialized data to the second remote vehicle service of the second system S2 or the third remote vehicle service of the third system S3 through the DRC protocol. The second or third remote vehicle service performs deserialization processing on the serialized data upon receiving the serialized data, obtains the identification information of the target screen and the corresponding launching instruction, and launches the interface of the application on the target screen corresponding to the identification information based on the launching instruction.

In another example of FIG. 4, when the second remote vehicle service monitors that there is an interface startup request of an application in the second system S2, the second remote vehicle service may parse the interface startup request to obtain the identification information of the target screen and the launching parameters for the application, and determine the target system where the target screen is located based on the identification information of the target screen. When the target system is the second system S2, the second remote vehicle service launches the interface of the application on the target screen of the second system S2. When the target system is the first system S1 or the third system S3, the second remote vehicle service serializes the identification information of the target screen and the launching parameters for the application to obtain serialized data and sends the serialized data to the first remote vehicle service of the first system S1 or the third remote vehicle service of the third system S3 through the DRC protocol. The first or third remote vehicle service performs deserialization processing on the serialized data upon receiving the serialized data, obtains the identification information of the target screen and the corresponding launching instruction, and launches the interface of the application on the target screen corresponding to the identification information based on the launching instruction.

In still another example of FIG. 4, when the third remote vehicle service monitors that there is an interface startup request of an application in the third system S3, the third remote vehicle service may parse the interface startup request to obtain the identification information of the target screen and the launching parameters for the application, and determine the target system where the target screen is located based on the identification information of the target screen. When the target system is the third system S3, the third remote vehicle service launches the interface of the application on the target screen of the third system S3. When the target system is the first system S1 or the second system S2, the third remote vehicle service serializes the identification information of the target screen and the launching parameters for the application to obtain serialized data and sends the serialized data to the first remote vehicle service of the first system S1 or the second remote vehicle service of the second system S2 through the DRC protocol. The first or second remote vehicle service performs deserialization processing on the serialized data upon receiving the serialized data, obtains the identification information of the target screen and the corresponding launching instruction, and launches the interface of the application on the target screen corresponding to the identification information based on the launching instruction.

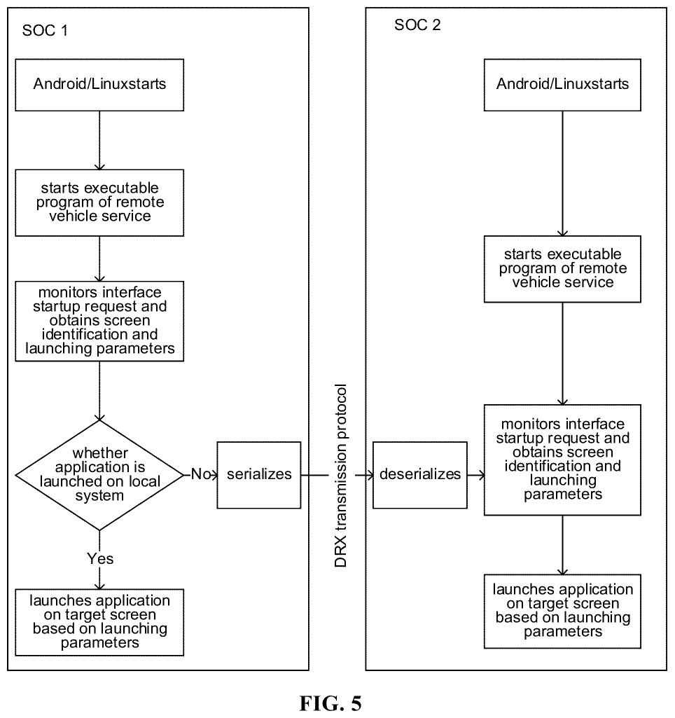

FIG. 5 is a schematic diagram illustrating a communication method according to an embodiment of the disclosure. As illustrated in FIG. 5, after the first SOC and the second SOC are powered on and started, the first SOC starts executable programs of the first remote vehicle service and the second SOC starts executable programs of the second remote vehicle service. The started first remote vehicle service and the started second remote vehicle service respectively listen to an interface startup request of an application in their respective systems. When the first remote vehicle service on the first SOC detects that there is an interface startup request, the first remote vehicle service parses the interface startup request to obtain the identification information of the target screen and the launching parameters for the application. The first remote vehicle service determines whether the first SOC is the target system corresponding to the target screen based on the identification information of the target screen, that is, whether the application is launched on the current system. When it is determined that the first SOC is the target system corresponding to the target screen (i.e. the application is launched on the current system), the first remote vehicle service launches the interface of the application on the target screen of the first SOC based on the launching parameters. When it is determined that the first SOC is not the target system corresponding to the target screen (i.e., the application is not launched on the current system), the first remote vehicle service determines the target system (such as the second SOC) based on the identification information of the target screen and serializes the identification information of the target screen and the launching parameters for the application to obtain serialized data. The first remote vehicle service sends the serialized data to the second remote vehicle service of the second SOC through the DRC transmission protocol. The second remote vehicle service of the second SOC performs deserialization processing on the received data to obtain the identification information of the target screen and the launching parameters for the application, to launch the interface of the application on the target screen in the second SOC based on the launching parameters.

It is understandable that after starting executable programs of the second remote vehicle service in the second SOC, the second remote vehicle service will listen to an interface start request of an application in the second SOC. When the second remote vehicle service on the second SOC detects that there is an interface startup request, the second remote vehicle service parses the interface startup request to obtain the identification information of the target screen and the launching parameters for the application and determines, based on the identification information of the target screen, whether the second SOC is the target system corresponding to the target screen. In response to determining the second SOC is the target system, the second remote vehicle service launches the interface of the application on the second SOC based on the launching parameters. In response to determining that the first SOC is the target system, the second remote vehicle service serializes the identification information of the target screen and the launching parameters for the application and sends the serialized data to the first remote vehicle service of the first SOC through the target communication service. The first remote vehicle service in the first SOC may deserialize the serialized data to obtain the identification information of the target screen and the launching parameters for the application, and then launch the interface of the application on the target screen in the first SOC based on the launching parameters.

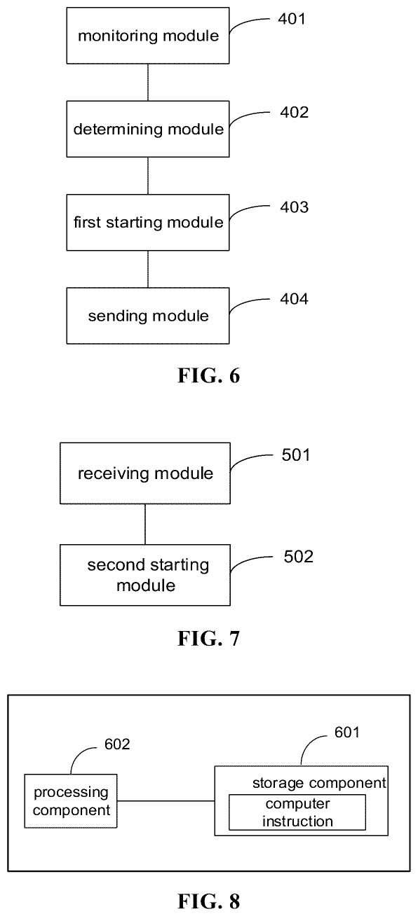

FIG. 6 is a block diagram illustrating a communication apparatus according to an embodiment of the disclosure. As illustrated in FIG. 6, the apparatus includes:
a monitoring module 401, configured to monitor an interface startup request of an application, in which the interface startup request includes identification information of a target screen to be started;
a determining module 402, configured to determine, based on the identification information, whether a target system corresponding to the target screen is the current system;
a first starting module 403, configured to, in response to determining, by the determining module, that the target system corresponding to the target screen is the current system, start an interface of the application on the target screen; and
a sending module 404, configured to, in response to determining, by the determining module, that the target system corresponding to the target screen is not the current system, send the interface startup request to the target system, to enable the target system to start the interface of the application on the target screen.

In embodiments of the disclosure, by monitoring the interface startup request of the application, it is determined whether the target system corresponding to the target screen to be started is the current system. When it is determined that the target system corresponding to the target screen is the current system, it indicates that the interface of the application will be started on the screen of the current system, and thus the interface of the application is started directly on the target screen of the current system. When it is determined that the target system corresponding to the target screen is not the current system, it indicates that the interface of the application will be started on the screen of another system. At this time, the interface startup request is sent to the target system, so that the interface of the application is started on the target screen of the target system. Therefore, the interface of the application in the system may be started on the screen of any system without the need to process the application, and it is possible to start the interface of the application on the screen of any system simply based on the identification information of the target screen to be started, which is simple and easy to implement, thereby improving the user experience.

In some embodiments, the system includes at least one screen.

The monitoring module 401 is configured to monitor the interface startup request of the application on any screen.

In some embodiments, each system includes a respective remote vehicle service.

The monitoring module 401 is configured to start the remote vehicle service, and monitor the interface startup request of the application by means of the remote vehicle service.

In some embodiments, the sending module 404 is configured to send the interface startup request to a remote vehicle service of the target system by means of the remote vehicle service.

In some embodiments, the interface startup request further includes launching parameters for the application and the apparatus further includes a parsing module, configured to parse the interface startup request by means of the remote vehicle service to obtain the identification information of the target screen and the launching parameters for the application; and a processing module configured to serializing the identification information of the target screen and the launching parameters for the application by means of the remote vehicle service to obtain serialized data. The sending module 404 is further configured to send the serialized data to the target system.

In some embodiments, the apparatus further includes:
a determining module, configured to determine a target communication service between the current system and the target system based on a preset correspondence between system types and communication services that are performed between systems.

The sending module 404 is configured to send the interface startup request to the target system through the target communication service.

The communication apparatus described in FIG. 6 may perform the communication method described in the embodiment shown in FIG. 1, and the implementation principle and technical effect thereof will not be repeated. The specific manner in which each of the modules and units of the communication apparatus in the above embodiment performs an operation has been described in detail in the embodiments relating to the methods, and will not be described herein in detail.

FIG. 7 is a block diagram illustrating another communication apparatus according to an embodiment of the disclosure. As illustrated in FIG. 7, the apparatus includes:
a receiving module 501, configured to receive an interface startup request of an application sent by a first system in a vehicle, in which the interface startup request includes identification information of a target screen to be started, the vehicle includes a plurality of systems, and the first system is a system in which the application is installed; and
a second starting module 502, configured to start an interface of the application on the target screen based on the identification information.

In some examples, the apparatus may be a target system including a target remote vehicle service. The apparatus further includes a deserialization module configured to deserialize the interface startup request by means of the target remote vehicle service to obtain identification information of the target screen and launching parameters for the application. The second starting module 502 is further configured to launch an interface of the application on the target screen based on identification information and the launching parameters.

In embodiments of the disclosure, by receiving the interface startup request sent by the first system in which the application is installed, based on the identification information of the target screen to be started included in the interface startup request, the interface of the application may be started on the target screen. Therefore, the interface of the application of another system may be started on the screen of the current system, and the interface of the application in the system may be started on the screen of any system without the need to process the application. It is possible to start the interface of the application on the screen of any system simply based on the identification information of the target screen to be started, which is simple and easy to implement, thereby improving the user experience.

The communication apparatus described in FIG. 7 may perform the communication method described in the embodiment shown in FIG. 3, and the implementation principle and technical effect thereof will not be repeated. The specific manner in which each of the modules and units of the communication apparatus in the above embodiment performs an operation has been described in detail in the embodiments relating to the methods, and will not be described herein in detail.

FIG. 8 is a block diagram illustrating a communication system according to an embodiment of the disclosure. As illustrated in FIG. 8, the communication system includes a storage component 601 and a processing component 602.

The storage component 601 may store one or more computer instructions, and the one or more computer instructions may be called by the processing component 602 for execution.

The processing component 602 may be configured to:
monitor an interface startup request of an application, in which the interface startup request includes identification information of a target screen to be started;
determine, based on the identification information, whether a target system corresponding to the target screen is the current system;
in response to the target system corresponding to the target screen being the current system, start an interface of the application on the target screen; and
in response to the target system corresponding to the target screen not being the current system, send the interface startup request to the target system, to enable the target system to start the interface of the application on the target screen.

In embodiments of the disclosure, by monitoring the interface startup request of the application, it is determined whether the target system corresponding to the target screen to be started is the current system. When it is determined that the target system corresponding to the target screen to be started is the current system, it indicates that the interface of the application will be started on the screen of the current system, and thus the interface of the application is started directly on the target screen of the current system. When it is determined that the target system corresponding to the target screen to be started is not the current system, it indicates that the interface of the application will be started on the screen of another system. At this time, the interface startup request is sent to the target system, so that the interface of the application is started on the target screen of the target system. Therefore, the interface of the application in the system may be started on the screen of any system without the need to process the application, and it is possible to start the interface of the application on the screen of any system simply based on the identification information of the target screen to be started, which is simple and easy to implement, thereby improving the user experience.

In some embodiments, the processing component 602 may also be configured to call one or more computer instructions to perform the communication method according to embodiments illustrated in FIG. 2 or FIG. 3, which is not described herein.

The processing component 602 may include one or more processors to execute the computer instructions, to complete some or all the blocks in the above methods. Certainly, the processing component may include one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, for performing the above described methods.

The storage component 601 is configured to store various types of data to support operations at the terminal. The storage component 601 may be implemented using any type of volatile or non-volatile storage devices, or a combination thereof, such as a Static Random-Access Memory (SRAM), an Electrically-Erasable Programmable Read Only Memory (EEPROM), an Erasable Programmable Read Only Memory (EPROM), a Programmable Read Only Memory (PROM), a Read Only Memory (ROM), a magnetic memory, a flash memory, a magnetic or optical disk.

Certainly, the communication system may necessarily include other components, such as an input/output interface, a communication component, and the like.

The input/output interface provides an interface between a processing component and a peripheral interface module. The peripheral interface module may be an output device, an input device and the like.

The communication component is configured to facilitate communication between the communication system and other devices in a wired manner or wirelessly.

Embodiments of the disclosure also provide a computer-readable storage medium having a computer program stored thereon. The computer program is configured to cause a processor to perform the communication methods according to embodiments illustrated in FIG. 1 or FIG. 2, or to perform the communication methods according to embodiments illustrated in FIG. 3. In some embodiments, the computer-readable storage medium is a non-transitory computer-readable storage medium.

Embodiments of the disclosure also provide a computer program including computer program codes. When the computer program codes are executed by a computer, the computer is caused to perform the communication methods according to embodiments illustrated in FIG. 1 or FIG. 2, or to perform the communication methods according to embodiments illustrated in FIG. 3.

Embodiments of the disclosure also provide a computer program product including a computer program. When the computer program is executed by a processor, the processor is caused to perform the communication methods according to embodiments shown in FIG. 1 or FIG. 2, or to perform the communication methods according to embodiments illustrated in FIG. 3.

In embodiments of the disclosure, by monitoring the interface startup request of the application, it is determined whether the target system corresponding to the target screen to be started is the current system. If it is determined that the target system is the current system, it indicates that the interface of the application will be started on the screen of the current system, and thus the interface of the application is started directly on the target screen of the current system. If it is determined that the target system is not the current system, it indicates that the interface of the application will be started on the screen of another system. At this time, the interface startup request is sent to the target system, so that the interface of the application is started on the target screen of the target system. Therefore, the interface of the application in the system may be started on the screen of any system without the need to process the application, and it is possible to start the interface of the application on the screen of any system simply based on the identification information of the target screen to be started, which is simple and easy to implement, thereby improving the user experience.

It is clear to those skilled in the field to which it belongs that, for the convenience and brevity of the description, the specific work processes of the systems, apparatuses, and units described above may be referred to the corresponding processes in foregoing method embodiments, and will not be repeated herein. The foregoing explanatory description of embodiments of the communication methods is also applicable to the computer-readable storage medium, the computer program product, and the computer program in foregoing embodiments, and will not be repeated herein.

The above-described embodiments of the apparatuses are merely schematic, in which the units described as illustrated as separated components may or may not be physically separated, and the components shown as units may or may not be physical units, i.e. they may be located in one place or distributed over a plurality of network units. Some or all of these modules may be selected to achieve the purpose of the technical solution of the embodiment according to actual needs. Those skilled in the art may understand and implement the method without inventive work.

Through the above description of the embodiments, it is clear to those skilled in the art that embodiments may be realized with the aid of software and the necessary general hardware platform, and by means of hardware. Based on this understanding, the above technical solutions which essentially or rather contribute to the related art may be embodied in the form of a software product, which may be stored in a computer-readable storage medium, such as a ROM/RAM, a diskette, a CD-ROM, etc., and includes a number of instructions to cause a computer device (which may be a personal computer, a server, or a network device, etc.) to execute the methods described in individual embodiment or certain parts of the embodiments.

It should be noted that above embodiments are only used to illustrate the technical solutions of the disclosure rather than limiting the technical solutions. Although the disclosure has been described in detail with reference to the foregoing embodiments, those skilled in the art should understand that the technical solutions recorded in the foregoing embodiments may be modified or some of the technical features therein may be replaced by equivalences. These modifications or substitutions do not cause the essence of the corresponding technical solutions to deviate from the spirit and scope of the technical solutions of the embodiments of the disclosure.

All embodiments of the disclosure may be performed alone or in combination with other embodiments and are considered to be within the scope of protection of the claims of the disclosure.

What is claimed is:

1. A communication method, performed by a source system in a vehicle, wherein the source system is any of a plurality of systems in the vehicle, and the method comprises:
monitoring an interface startup request of an application, wherein the interface startup request comprises identification information of a target screen to be started;
determining, based on the identification information, whether a target system corresponding to the target screen is the source system;
in response to the target system corresponding to the target screen being the source system, starting an interface of the application on the target screen; and
in response to the target system corresponding to the target screen not being the source system, sending the interface startup request to the target system, to enable the target system to start the interface of the application on the target screen.

2. The method of claim 1, wherein the source system comprises at least one screen, and monitoring the interface startup request of the application comprises:
monitoring the interface startup request of the application on any screen.

3. The method of claim 1, wherein the source system comprises a remote vehicle service, and monitoring the interface startup request of the application comprises:
starting the remote vehicle service; and
monitoring the interface startup request of the application through the remote vehicle service.

4. The method of claim 3, wherein the target system comprises a target remote vehicle service and sending the interface startup request to the target system comprises:
sending the interface startup request to the target remote vehicle service of the target system through the remote vehicle service.

5. The method of claim 4, wherein the interface startup request further comprises launching parameters for the application, and before sending the interface startup request to the target remote vehicle service of the target system through the remote vehicle service, the method further comprises:
parsing the interface startup request by the remote vehicle service to obtain the identification information of the target screen and the launching parameters for the application; and
serializing the identification information of the target screen and the launching parameters for the application by the remote vehicle service to obtain serialized data; and
wherein sending the interface startup request to the target remote vehicle service of the target system through the remote vehicle service comprises:
sending the serialized data to the target remote vehicle service of the target system by the remote vehicle service.

6. The method of claim 1, further comprising:
determining a target communication service between the source system and the target system based on a preset correspondence between system types and communication services that are performed between systems; and
wherein sending the interface startup request to the target system comprises:
sending the interface startup request to the target system through the target communication service.

7. The method of claim 1, wherein the plurality of systems comprise a plurality of systems on chip.

8. A communication method, performed by a target system in a vehicle, wherein the target system is any of a plurality of systems in the vehicle, and the method comprises:
receiving an interface startup request of an application sent by a first system in a vehicle, wherein the first system is different from the target system, the interface startup request comprises identification information of a target screen to be started, and the first system is a system in which the application is installed; and
starting an interface of the application on the target screen based on the identification information.

9. The method of claim 8, wherein the target system comprises a target remote vehicle service, and after receiving the interface startup request of the application sent by the first system, the method further comprises:
deserializing the interface startup request by the target remote vehicle service to obtain the identification information of the target screen and launching parameters for the application; and
starting an interface of the application on the target screen based on the identification information of the target screen and the launching parameters for the application.

10. A source system, comprising:
a processor; and
a memory for storing instructions executable by the processor;
wherein the processor is configured to:
monitor an interface startup request of an application, wherein the interface startup request comprises identification information of a target screen to be started;
determine, based on the identification information, whether a target system corresponding to the target screen is the source system, wherein the target system is any of a plurality of systems in the vehicle;
in response to the target system corresponding to the target screen being the source system, start an interface of the application on the target screen; and
in response to the target system corresponding to the target screen not being the source system, sending the interface startup request to the target system, to enable the target system to start the interface of the application on the target screen.

11. The source system of claim 10, comprising at least one screen, and the processor is configured to:
monitor the interface startup request of the application on any screen.

12. The source system of claim 10, comprising a remote vehicle service, and the processor is configured to:
start the remote vehicle service; and
monitor the interface startup request of the application through the remote vehicle service.

13. The source system of claim 12, wherein the processor is configured to:
send the interface startup request to a target remote vehicle service of the target system through the remote vehicle service.

14. The source system of claim 13, wherein the interface startup request further comprises launching parameters for the application, and the processor is configured to:
parse the interface startup request by the remote vehicle service to obtain the identification information of the target screen and the launching parameters for the application; and
serialize the identification information of the target screen and the launching parameters for the application by the remote vehicle service to obtain serialized data; and
send the serialized data to the target remote vehicle service of the target system by the remote vehicle service.

15. The source system of claim 10, wherein the processor is further configured to:
determine a target communication service between the source system and the target system based on a preset correspondence between system types and communication services that are performed between systems; and
send the interface startup request to the target system through the target communication service.

16. The source system of claim 10, wherein the plurality of systems comprise a plurality of systems on chip.

17. A target system, comprising:
a processor; and
a memory, for storing instruction executable by the processor;
wherein the processor is configured to perform the method of claim 8.

18. A non-transitory computer readable storage medium having a computer program stored thereon, wherein the computer program is configured to cause a processor to perform the communication method of claim 1.

19. A non-transitory computer readable storage medium having a computer program stored thereon, wherein the computer program is configured to cause a processor to perform the communication method of claim 8.
